(19) United States
(12) Patent Application Publication
(10) Pub. No.: US 2025/0153428 A1
(43) Pub. Date: May 15, 2025

(54) Method for producing a three-dimensional body

(71) Applicants: FIT AG, Lupburg (DE); Hyphaen A.p.S., København V (DE)

(72) Inventors: Bruno Knychalla, Lupburg (DE); Ana Goidea, København V (DE)

(21) Appl. No.: 18/748,832

(22) Filed: Jun. 20, 2024

(30) Foreign Application Priority Data
Jun. 19, 2023 (DE) 10 2023115996.8

(51) Int. Cl. B29C 64/165; A01G 18/00; B33Y 10/00; B33Y 70/00

(52) U.S. Cl. CPC B29C 64/165; A01G 18/00; B33Y 10/00; B33Y 70/00

(57) ABSTRACT

The invention relates to a method for producing a three-dimensional body, in particular layer by layer. The method comprises a step of providing (I) a fungus-containing bonding agent (26). The method comprises a step of laying out (II) particles (28) in at least one particle layer (14) over a print bed (22). The method comprises a step of applying (III) the fungus-containing bonding agent (26) in a defined area of the particle layer (14). The method comprises a step of inducing (IV) a growth of a fungal mycelium (24) from fungus-containing bonding agent (26) to structurally connect particles (28) of the particle layer (14) to form a green body (32). The method comprises a step of exposing (V) the green body (32).

### TECHNICAL FIELD

The present invention relates to a method for producing a three-dimensional body, in particular a body comprising fungal mycelium.

### STATE OF THE ART

Additive manufacturing processes have been known for many years. They enable an easy production of three-dimensional bodies with complex geometries that are difficult or impossible to realize with conventional manufacturing processes. Processes for producing three-dimensional bodies using fungi, especially fungal mycelium, are still in their infancy. The field is new and is undergoing rapid development. Possible areas of application are still being researched, but applications in art and interior design have already emerged.

### DESCRIPTION OF THE INVENTION

The invention relates to a method for manufacturing a three-dimensional body. The method is a method for additive manufacturing. The three-dimensional body produced by the method extends in all 3 spatial directions, which are arranged orthogonally to one another. The three-dimensional body produced comprises at least one fungal mycelium. A fungal mycelium is the mycelium of a fungus. A fungal mycelium is an accumulation of hyphae. Hyphae form branched, single-stranded filaments. Hyphae and mycelium can transmit oxygen, nutrients, water and/or signals. A fungal mycelium can grow from fungal spores. The fungal mycelium can transmit forces, especially tensile forces. The fungal mycelium can decompose lignin, cellulose, glucose and/or other substances. The fungal mycelium can grow. The fungal mycelium can react to environmental conditions. The fungal mycelium may stop growing under certain environmental conditions. It may also start growing again under certain environmental conditions. The fungal mycelium may stop and start growing again multiple times. Environmental conditions may be humidity, oxygen content, light, temperature and/or the presence of nutrients.

The three-dimensional body comprises particles. The particles are connected to each other by the mycelium. The mycelium surrounds the particles. The mycelium can grow into the particles. The particles can be made of wood, in particular beech or oak. The particles can comprise an average diameter of between 0.01 and 100 millimeters, in particular between 0.1 and 10 millimeters. The particles can have a round shape. The particles can have an irregular shape. The particles may comprise wood pellets. The particles may then comprise a cylindrical shape. The particles may comprise wood chips. The particles may comprise wood chips compressed into wood pellets. The particles may comprise non-organic material. For example, the particles may be made of metal. For example, the particles may comprise aluminum, steel, copper and/or iron. If the particles are made of metal, the mycelium has not grown into the particles, but the particles are only surrounded by mycelium.

The method comprises a step of providing a fungus-containing compound. Providing can be manufacturing. Providing can also be filling a container. For example, a container may be a bonding agent reservoir which may be connected via tubes to a distribution device, such as a nozzle. A fungus-containing bonding agent comprises parts of a fungus, in particular a mycelium-forming fungus. A part of a fungus may be fungal mycelium. Part of a fungus may also be fungal spores. A part of a fungus may also be a fruiting body of a fungus. The part of the fungus is alive. The fungus-containing bonding agent comprises a fungal mycelium. Alternatively or additionally, the bonding agent may comprise fungal spores and/or the fruiting body of a fungus from which the fungal mycelium develops. The bonding agent is a substance that is designed to mechanically connect particles to each other. The bonding agent does not have to be formed to connect particles immediately upon contact with the particles. The bonding agent is designed to build up a connection between particles over a longer period of time, for example several days, through the growth of fungal mycelium. The bonding agent may thereby partially decompose the particles. The bonding agent is designed to enable the growth of fungal mycelium. For example, the bonding agent may comprise fungal mycelium, which can grow. The bonding agent may also comprise fungal spores which are designed to grow into fungal mycelium. The binding agent may comprise food, for example agar, glucose, fructose, carbohydrates, fatty acids and/or salts. The bonding agent may also comprise wood, lignin and/or cellulose. The bonding agent may additionally comprise an adhesive agent which bonds particles and/or fungal mycelium together, for example alginate. The bonding agent may comprise an antibiotic to inhibit bacterial growth. The bonding agent may comprise a nutrient for a fungus. The bonding agent may comprise a water component.

The bonding agent may be viscous and in particular a paste. The bonding agent may be spreadable. A paste may be a suspension, which means that the paste may comprise mixed liquid and solid phases. The liquid phase may comprise water. The bonding agent may also be a liquid. If the bonding agent is a liquid, the bonding agent comprises suspended fungal mycelium and/or fungal spores. The bonding agent may also be solid. If the bonding agent is solid, it may consist of particles. If the bonding agent consists of particles, the particles can be movable in relation to each other. If the bonding agent consists of particles, all particles may comprise the same or almost the same composition. If the bonding agent consists of particles, the particles may also comprise different compositions. For example, the bonding agent may comprise particles comprising a fungus, nutrients, wood, lignin, cellulose, an antibiotic and/or an adhesive. The bonding agent may also be liquid. If the bonding agent is liquid, it may be sprayed.

The method comprises a step of laying out particles in at least one particle layer over a print bed. The laying out may be a distributing. The laying out may be accomplished via a coater. The laying out can be a distributing into a layer of uniform thickness. The laying out can be a laying out that lays out a smooth or flat particle layer. The laying out can cover an entire surface over a print bed. A particle layer comprises particles.

A particle layer can be between 0.1 millimeters and 100 millimeters thick. In particular, a particle layer can be between 1 millimeter and 10 millimeters thick. A particle layer can comprise free spaces between the particles. The free spaces can be designed so that a bonding agent can penetrate into them. A particle layer can be arranged vertically above another particle layer.

A coater is a device that distributes particles in a particle layer. It is configured to lay out particles from a particle reservoir on the print bed described below. The coater may also remove excess particles and/or smooth a particle layer. The coater is movable horizontally, i.e. parallel to the direction in which the print bed extends. The coater may also be movable vertically, i.e. in the height direction of the production system. The coater may comprise a width that essentially corresponds to the width of the print bed, so that the coater may extend across the print bed. The coater may be mounted along rails, which may be arranged at margin areas of the production system. The rails may be hung above the production system. The coater may be arranged on a crane or on a coating robot. The coater may comprise a starting position at an outer edge of the production system. The coater may be moved by electric motors. The coater may be moved by a crane or a coating robot.

A coater may comprise a particle reservoir. A particle reservoir is a container for particles. The particle reservoir is connected to a coater opening. Particles may exit the coater from a particle reservoir via a coating opening. In particular, they may be distributed in a particle layer via a coating opening. The particle reservoir may be configured in such a way that sufficient particles can be kept in stock to fill an entire print volume. A print volume may be the volume enclosed by the margin areas and located between a first and a second position of the print bed in the vertical direction. The particle reservoir may be configured so that it can be filled during production. The particle reservoir is connected to a coater opening of the coater. The particle reservoir may be connected to the coater opening via a tube or hose. The coater opening may comprise a width that is equal or nearly equal to a width of the print bed. The coater opening is configured to allow particles to emerge from a particle reservoir onto a print bed. The particles may be forced outwards by gravity. The particles may be forced outwards by applying pressure. The particles may be forced outwards by a piston. The particles may be forced outwards by a screw conveyor.

A print bed is a device configured to support layers of particles. A print bed may be vertically movable. A print bed may comprise a threaded spindle. A print bed may comprise a print bed plate. The print bed plate may be moved along a vertical direction. In particular, the print bed plate may be moved downwards by a thickness of a particle layer before laying out the particle layer. A print bed can be moved vertically so that the top layer rests against an upper edge of a production line. The print bed plate can be moved vertically via the threaded spindle. A threaded spindle may cause a linear movement from a rotational movement. For example, the threaded spindle is rotated by a rotation increment via an electric motor. The print bed plate can be moved vertically in predefined increments. The predefined increments can be determined by a computer, correspond to a thickness of a particle layer and/or be specified by a user. The vertical movement of the print bed plate may be a lowering. The print bed plate may also be moved vertically by a pneumatic device. The print bed may comprise a position sensor to determine the vertical position of the print bed plate. The position sensor may measure a distance to an underside of the print bed plate and/or to a floor of the production system. The position sensor can additionally or alternatively count the rotation increments of the electric motor to determine the position of the print bed plate. The print bed can be connected to a ventilation device for ventilating the three-dimensional body. The print bed can have sensors, such as a position sensor, an acceleration sensor, a weight sensor, a temperature sensor and/or an oxygen sensor.

Margin areas of a production system can be arranged around the print bed. The margin areas are configured to prevent the particle layers from escaping from the production system. The margin areas are arranged around a print bed. Fastening means for a coater, for a robot, for a particle reservoir and/or a fastener reservoir may be arranged at the margin areas. Devices for moving the coater, the robot, the particle reservoir and/or the bonding agent reservoir may be arranged at the margin areas. In particular, the devices may comprise rails. The margin areas may comprise catching openings. The catching openings may be designed to catch particles that protrude beyond the edges of the print bed. The catching openings may be configured to catch particles that are displaced beyond the edges of the print bed by the coater and/or the robot. The catching openings may be connected to a catching reservoir. The particles that enter the catching openings may be conveyed into a catching reservoir by gravity, by a screw conveyor, by a piston, by a draft of air and/or by other devices. The particles in the catching reservoir may be used for a further manufacturing process. The particles in the initial reservoir may be returned to the particle reservoir of the coater. The particles may be filtered, cleaned, moistened and/or sterilized before being reused and/or returned to the particle reservoir of the coater.

The method comprises a step of applying the bonding agent to a defined area of the particle layer. Applying may comprise placing the bonding agent on the particle layer. Applying may also comprise pressing it into the particle layer, displacing the particles of the particle layer, infiltrating between the particles, wetting the particles and/or sticking the particles of the particle layer together. A defined area may be a point. A defined area may also be a line or a path. A defined area may also be a volume. The quantity of defined areas corresponds to the volume or geometry of the three-dimensional body produced. For example, a defined area may be a cross-section of the manufactured three-dimensional body. For example, a defined area may be the entire volume of a manufactured body. Defined areas may correspond to the areas in which bonding agent is applied.

An application may be performed using a robot. The robot may comprise an effector, a nozzle and a bonding agent reservoir. The robot may be configured to apply the bonding agent via the effector and the nozzle from the bonding agent reservoir in a defined area of the particle layer. The robot may be configured to move the effector over a print layer. The robot may be arranged outside the print bed or next to the print bed. However, the robot may also be arranged at margin areas and/or above the print bed. The robot may be mobile or movably mounted, for example it may be mounted on rails. The robot may be a 2-, 3-, 4-, 5- or 6-axis robot. The robot may be an industrial robot. The robot may be a collaborative robot. The robot may be an articulated robot, a delta robot or a Cartesian robot.

The effector may be arranged at one end of the robot. The effector may be configured to apply the bonding agent from the bonding agent reservoir to a particle layer. The effector may be a peristaltic effector. The effector may comprise a spray device. The effector may be connected to a bonding agent reservoir. The effector may be connected to the bonding agent reservoir via a hose or a tube. The nozzle may be attached to the effector. The nozzle may be configured to convey the bonding agent through the nozzle. The nozzle may convey solid substances. The nozzle may also convey liquid substances. The bonding agent may be forced through the nozzle via a peristaltic pump, a screw conveyor, gravity, a piston and/or pressurization from the bonding agent reservoir. The bonding agent is applied by forcing it outwards over the particle layer.

The bonding agent reservoir may be arranged above the effector. The lanyard reservoir may also be arranged next to or in the effector or not at the effector. The bonding agent reservoir may, for example, also be arranged on the robot or at a margin area.

The bonding agent reservoir may be configured to store the bonding agent described above. The bonding agent reservoir may be configured in such a way that sufficient bonding agents can be stored in order to carry out a manufacturing process. The bonding agent reservoir may be configured so that it can be filled during a manufacturing process. The bonding agent may be applied to a particle layer from the bonding agent reservoir via the nozzle. The bonding agent may be introduced into the particle layer and placed between the particles.

The robot, the print bed and the coater may be controlled by a control device. The control device may be configured to transmit control signals. Additionally, the control device may control a ventilation device. The control device may comprise a computer. The computer may be a personal computer, such as a desktop computer or a laptop computer. However, the computer may also be an integrated microcontroller or another type of computer. The control device may be connected to the controlled components electronically, for example via a bus system. However, the control device may be connected to the controlled components via data cables or wirelessly. The control device may also comprise several computers, each of which may be connected to the connected components. The multiple computers may be located at the respective connected component or at remote locations.

The control device may be configured to store data for the production of a three-dimensional body and to provide control signals for the production of a three-dimensional body based on this data. The control signals may be transmitted from the control device to the connected components in order to control the connected components via the control signals. The stored data may, for example, be a digital three-dimensional model of a body to be manufactured. The stored data may also be digital representations of cross-sections of a body to be finished, which are also referred to as “slices”. The stored data may also be specifications for movement paths and movement speeds of the robot, the effector, the coater and/or the print bed. The stored data may also be specifications for the operation of a ventilation device, in particular a compressor, and may contain specifications for the amount of air and oxygen concentration.

The three-dimensional body may be built up in a separate room or chamber, which is filled with a special atmosphere, which may be a gas mixture or sterile air, which is under slight overpressure in order to prevent contamination of the object already during production. The separated space or chamber may be filled with the special atmosphere before the step of inducing growth. The separated space or chamber may also be filled with the special atmosphere before a step of laying out particles. The special atmosphere may be maintained during a step of inducing growth. The special atmosphere may also be maintained beyond the step of inducing growth. It is also possible to compose the special atmosphere differently in the different process phases. In particular, the composition of the special atmosphere may include a temperature, a humidity and/or an oxygen content. The special atmosphere may be sterilized and/or purified via filters and/or UV radiation. The separated space or chamber may surround the particle layers, the fungus-containing bonding agent, a bonding agent and/or other bodies surrounded by the particle layers. The separated space or chamber may also surround the entire production system. The separated space or chamber may also surround a part of the manufacturing plant.

The method comprises a step of inducing growth of a mycelium from the fungus-containing bonding agent to structurally connect the particles to form a green body. Inducing is an action or omission of an action that causes or does not inhibit the growth of the fungal mycelium. For example, inducing may also be waiting. Inducing may be allowing to grow. Allowing to grow means that no active action is performed that causes growth and no action is performed that prevents or inhibits growth. Inducing may be the provision of moisture, nutrients, temperature, oxygen, light and/or other environmental conditions that may positively influence the growth of a fungal mycelium. The step of inducing growth may also comprise ventilating.

A growth comprises a multiplication of cells of the fungal mycelium. A growth comprises an enlargement of the fungal mycelium. A growth may comprise a penetration of the fungal mycelium into particles. The growth comprises an interconnection of the fungal mycelium to form a structure. A structural connecting is a mechanical connecting. A structural connecting forms a structure that may transmit mechanical forces. In particular, the structure may transmit tensile forces. A green body is an intermediate product of the production of the three-dimensional body. A green body corresponds geometrically to a three-dimensional body to be manufactured. A green body is a body that has to go through further manufacturing steps. A green body may comprise living fungal mycelium. A green body may comprise the same dimensions and geometric shape of the fully manufactured three-dimensional body. A green body may comprise a fungal mycelium that continues to grow. A green body may be rigid. A green body may be mechanically stable. A green body may also be easily mechanically deformable.

The method comprises a step of exposing the green body. Exposing is a removal of the green body from a surrounding material. In particular, exposing is a removal of the green body from the particle layers and the manufacturing system. Exposing may be carried out using compressed air. Exposing may in particular be carried out using sterile air. Sterile air is ambient air that has been filtered and/or sterilized. The method described may in particular be carried out layer by layer. A carrying out layer by layer is a repetition of at least one manufacturing step with the effect that the manufactured body comprises several layers. The multiple layers may be connected to each other. In particular, a layer by layer process is the repetition of the steps of laying out a particle layer, applying a connecting agent and lowering a print bed. The layer by layer method may comprise additive manufacturing.

A three-dimensional body produced according to the method described comprises several advantageous properties. The manufactured body is particularly light. The manufactured body may comprise cavities. The material of the body thus produced is also particularly light. The body thus manufactured can enclose a particularly large amount of air. The cavities are created by the growth of the fungal mycelium. The manufactured body can be produced without the use of plastics. The production of the body produced in this way is particularly low in CO2 and therefore particularly environmentally friendly. The body produced in this way has excellent acoustic properties. Due to its structure and material, the manufactured body absorbs sound and noise very well. The body produced in this way may provide a moisture buffer. The manufactured body may therefore reduce fluctuations in the humidity of a room. The manufactured body comprises a particularly aesthetically pleasing shape.

The manufactured body may comprise property gradients. This may be achieved by varying the materials used during production. The body created may incorporate additional structures by embedding them in the body during or after production. The manufacturing process offers particular freedom in the geometric design of a body and overhangs and other geometric shapes are easy to produce because the manufactured body is supported by a particle layer during production. In contrast to a process such as extrusion, overhangs may be produced without problems. The body produced in this way may comprise living mycelium. It is therefore possible to connect several bodies produced using this process by bringing them into contact with each other to allow the mycelium to grow together. Structures that are particularly large may thus be produced, in particular structures that are larger than the dimensions of a production system's installation space. Several components may be joined together without additional fasteners such as screws or clamps. This also enables a particularly clean and elegant appearance of the end product. The body produced in this way has a particularly high artistic value due to its particularly appealing aesthetics and connection with living biological material.

In one embodiment of the process, the fungus-containing bonding agent comprises a nutrient for the fungus and/or an adhesive. The nutrient may comprise, for example, agar, glucose, fructose, carbohydrates, fatty acids, minerals and/or salts. The bonding agent may comprise wood, lignin and/or cellulose. The adhesive may be an organic adhesive, in particular alginate. The adhesive supports a connection of the fungal mycelium with and in the particle layer. The supporting may be an adhesive bonding. By means of an adhesive bonding, the position of the bonding agent within a defined area may be supported or enabled. The adhesive may thus support a more precise determination of the geometry of the three-dimensional body to be produced. If the adhesive consists of an organic adhesive, it may be biodegradable. The adhesive may be degradable by the fungal mycelium. The adhesive may also be a nutrient. The nutrient supports the growth of the fungal mycelium. The fungal mycelium may use the nutrient to grow, multiply, expand and/or degrade lignin and/or cellulose. If the adhesive is a nutrient, the production of the bonding agent may be simplified. If the adhesive is a nutrient, the bonding agent may be more environmentally friendly. If the adhesive is a nutrient, the bonding agent may be biodegradable and more environmentally friendly.

In a further embodiment of the method, the providing of the fungus-containing bonding agent comprises a providing of a fungus-containing bonding agent comprising a wood-decomposing fungus, in particular Trametes and/or Ganoderma. The wood-decomposing fungus may decompose wood aerobically. The wood-decomposing fungus may also decompose wood anaerobically. In particular, the wood-decomposing fungus may decompose lignin and/or cellulose. The wood-decomposing fungus may feed on wood, in particular lignin and/or cellulose. The wood-decomposing fungus may grow into wood and wood particles and decompose internal parts of the wood. The wood-decomposing fungus may also decompose the surface or outside of a piece of wood. In particular, the wood-decaying fungus may comprise a fungal mycelium. The fungal mycelium of the wood-decomposing fungus may thus at least partially decompose wood particles. In the process, the fungal mycelium grows into the particles and thus forms a mechanical connection between the particles. Such a connection may be more stable than an exclusive surrounding of the particles with fungal mycelium.

In a further embodiment of the method, the laying out of the particles comprises a laying out of particles of organic material, in particular wood, preferably beech. Organic material may be material of biological origin. The organic material may also comprise fungi, algae, plant material and/or animal material. If the organic material comprises wood, it may comprise beech, lime, oak, olive wood, apple wood, fir wood and/or bamboo. Organic material may also be material comprising carbon atoms in its molecular structure. Forming the particles with organic material enables the fungal mycelium to at least partially decompose the particles. The fungal mycelium grows into the particles and thus forms a mechanical connection between the particles. Such a bond may be more stable than an exclusive surrounding of the particles with fungal mycelium.

In a further embodiment of the method, the method comprises a sterilizing of the particles, preferably prior to laying out the particles. A sterilizing may comprise a heating, an irradiating, a chemically treating, a freezing, a pressurizing and/or an exposing to a vacuum. A heating process may comprise a warming up to a high temperature, in particular above 30° C., preferably above 50° C., particularly preferably above 100° C. and for example above 200° C. A heating process may comprise controlling the temperature in order to keep the temperature below 500° C., 300° C. or 200° C., for example. An irradiating may comprise an irradiating with UV rays. An irradiating may also comprise an irradiating with infrared rays. An irradiating may also comprise an irradiating with radioactive radiation, in particular with alpha radiation, beta radiation, X-ray radiation, gamma radiation and/or neutron radiation. A chemically treating may comprise a treating with chemical substances, in particular with an alcohol, isopropanol, acetone, an acid, a base and/or a salt. A freezing process may comprise lowering the temperature.

In particular, a freezing process may comprise a lowering of the temperature below 0° C., below −10° C., below −30° C., below −70° C., below −100° C., below −150° C. or below −200° C. A pressurizing with high pressure may comprise a pressurizing with a pressure above atmospheric pressure, for example above 1.05 bar, above 1.5 bar, above 2 bar, above 10 bar, above 100 bar or above 200 bar. An exposing to a vacuum may comprise a lowering of the pressure below 0.5 bar, below 0.1 bar, below 0.01 bar or below 0.0001 bar.

Through the sterilization of the particles, unwanted organisms such as bacteria, animals, plants, viruses and/or fungi are removed or killed from the particles. Thus, unexpected, undesirable and/or disruptive growth of organisms is prevented before, during or after the production of the three-dimensional body. Through the sterilization, a competition between the fungal mycelium of the bonding agent with another fungus may be avoided. Through the sterilization, an infestation of the fungal mycelium with diseases may be avoided. Through the sterilization a growth of the fungal mycelium may be supported. Through the sterilization may an unwanted death of the fungal mycelium be avoided. Through the sterilization a rotting of the particles before, during and/or after the production may be avoided. Through the sterilization unpleasant odors may be avoided. By keeping the particles below a predetermined temperature, charring, ignition and/or decomposition of the particles during sterilization may be avoided.

In a further embodiment of the method, the inducing of a growth comprises at least one of the steps of adjusting, in particular controlling, the temperature, adjusting, in particular controlling, the humidity, and adjusting, in particular controlling, the oxygen content. The adjusting, in particular the controlling, may take place in the separate room or chamber already described. The adjusting of a temperature may be an adjusting of a temperature which particularly supports the growth of the fungal mycelium. The temperature may be kept constant throughout the growth of the fungal mycelium. The temperature may also however be varied during the growth of the fungal mycelium. For example, a higher temperature may be set in an initial phase of growth, and a lower temperature may be set in a later phase of growth. A lower temperature may also be set at an initial stage of growth and a higher temperature may be set at a later stage of growth. The set temperature may be a temperature that occurs in the natural habitat of the fungal mycelium. The set temperature may be a temperature that is comparable to the temperature in a forest. The temperature may also be controlled. For example, the temperature may be measured using a thermometer and a heating device controlled on the basis of the thermometer's measurement. The set or controlled temperature may be between 0° C. and 40° C. In particular, this temperature may be between 10° C. and 30° C., between 20° C. and 30° C. or between 20° C. and 25° C.

The adjusting of a humidity may be an adjusting of a humidity which particularly supports the growth of the fungal mycelium. The humidity may be kept constant throughout the growth of the fungal mycelium. However, the humidity may also be varied during the growth of the fungal mycelium. For example, a higher humidity may be adjusted in an initial phase of growth, and a lower humidity may be adjusted in a later phase of growth. A lower humidity may also be adjusted in an initial phase of growth and a higher humidity in a later phase of growth. The adjusted humidity may be a humidity that occurs in the natural habitat of the fungal mycelium. The adjusted humidity may be a humidity comparable to the humidity in a forest. The humidity may also be controlled. For example, the humidity may be measured via a hygrometer and a humidity device may be controlled based on the hygrometer's measurement. The humidity may be a humidity of the air. The humidity may also be a humidity of the bonding agent, the particle layers or the green body. The humidity may be between 0% and 30%. The humidity may also be between 30% and 70%. The humidity may also be between 70% and 100%. The humidity may also be 0% or 100%.

The adjusting of an oxygen content may be an adjusting of an oxygen content which particularly supports the growth of the fungal mycelium. The oxygen content may be kept constant throughout the growth of the fungal mycelium. However, the oxygen content may also be varied during the growth of the fungal mycelium. For example, a higher oxygen content may be adjusted in an initial phase of growth, and a lower oxygen content may be adjusted in a later phase of growth. A lower oxygen content may also be adjusted in an initial phase of growth and a higher oxygen content in a later phase of growth. The adjusted oxygen content may be an oxygen content that occurs in the natural habitat of the fungal mycelium. The adjusted oxygen content may be an oxygen content comparable to the oxygen content in a forest. For example, the oxygen content may be 21%. The oxygen content may also be over 21%, over 50% or 100%. The oxygen content may also be controlled.

Through the adjusting of a temperature, humidity and/or oxygen content, favorable environmental conditions for the growth of the fungal mycelium are created. The fungal mycelium may thus grow faster, penetrate deeper into the particles and/or form stronger connections. Through the adjusting of the environmental conditions, the growth rate of the fungal mycelium may also be controlled. For example, the growth rate may also be reduced. The growth rate may also be accelerated. The growth rates of organisms other than the fungal mycelium may also be influenced. For example, the growth of bacteria, algae, fungi and/or plants may be slowed down or accelerated. The growth of may also be prevented.

In a further embodiment of the method, the method comprises a ventilating of the green body, in particular a ventilating of the green body with sterile air, wherein the ventilating of the green body preferably comprises a ventilating by means of a device in the print bed of a production system. A ventilating is a providing of air in at least one particle layer. The air is provided to a green body by the particle layer, in particular to the fungal mycelium in the green body. The ventilating is carried out via a ventilation device. The ventilation device may comprise a compressor and, for example, ventilation tubes. The compressor may compress air, which is supplied to the particle layers and the green body via the ventilation tubes. Alternatively or additionally to the compressor, the air may also be supplied via a pressurized canister. Alternatively or in addition to the compressor, the air may also be provided by connecting it to the ambient air via an opening. Alternatively or additionally, air may also be provided via a chemical reaction. A device in the print bed may comprise ventilation holes in the print bed. The ventilating may also be carried out by a ventilating device in the margin areas of the production system. The ventilating may also be carried out by a ventilation device that is inserted into the particle layers. For example, ventilation tubes may be inserted into the particle layers and provide air. Ventilating a green body may involve surrounding the green body with air. The air may also penetrate the green body. The air may penetrate the green body via pores. The air may also penetrate the green body through diffusion processes. The air may be transported by the fungal mycelium from a surface of the green body into an inner volume of the green body. Sterile air is ambient air that has been filtered and/or sterilized. The ambient air may be sterilized by heating it, for example to over 100° C., over 200° C. or over 500° C. The ambient air may also be sterilized by irradiation, for example by irradiation with UV rays. The supplied air may also be pure oxygen. The supplied air may also be oxygen-enriched ambient air, for example with an oxygen content of more than or equal to 50%. The supplied air may comprise an oxygen content of 21%. The supplied air may be filtered before being supplied.

The growth of the fungal mycelium is supported by a ventilating. The growth of the fungal mycelium comprises a networking of the mycelium and thus the formation of a green body. The ventilating may accelerate a growth of the fungal mycelium, enable a growth of the fungal mycelium, enable a denser networking and/or enable a stronger networking. A stronger networking may be a networking by more hyphae, by thicker hyphae and/or by mechanically more resistant hyphae, whereby the hyphae form the fungal mycelium. The ventilating may support a growth of the fungal mycelium in a particular structure. For example, the ventilating may support growth in a particularly porous structure. The ventilating may also support growth in a particularly dense structure. The ventilating may promote growth into a particularly uniform structure, in particular with small differences across the height of the finished body.

In a further embodiment of the method, the method comprises transferring the at least one particle layer and the applied bonding agent from a production device to a growth device. A production device may be a production system. The transferring may also comprise a transferring of adhesive, additive and other substances or devices supplied during the manufacturing process. The transferring is a transferring with the least possible displacement of the particle layers and the bonding agent from one another. The transferring is carried out by raising the print bed, whereby the material to be transferred is lifted over the edge area of the production system and may be transferred. The transferring may be carried out by means of interlocking walls or plates, which are interlocked over the margin areas and around the print bed. They may be joined together before the print bed is raised. After a raising, another plate may be pushed between a particle layer and the print bed, so that the material to be displaced lies in a container formed in this way. The container thus formed may then be removed by hand, by crane, by rails or by another device together with the material to be displaced. The transferring may also be carried out using a device in a lower area of the production system. The transferring may also be carried out without raising the print bed. The transferring may also be a lifting out of the production system by means of a device.

A growth device is a device which is configured to enable and/or promote the growth of a fungal mycelium. The growth device may comprise a separate room or chamber as described above. The growth device may be a compartmentalized space or chamber as described above. The growth device may enable and/or perform an already described adjusting, in particular controlling, of humidity, temperature and/or oxygen content.

By transferring the material from a production device, the production device may be prepared for the production of another body before the growth of the fungal mycelium is completed. This may increase the throughput of the production device and efficiency, as well as reduce material consumption, electricity consumption, gas consumption and/or costs. By transferring it to a growth device, the process of growing may be simplified. The growth device may comprise more ergonomic, more favorable and/or mechanically simpler connections or devices to enable ventilation, adjustment of temperature, humidity or oxygen content or adjustment of other environmental conditions. Furthermore, the transferring allows a transporting for further processing steps and thus allows a more flexible design of the manufacturing process.

In a further embodiment of the method, the method comprises an arresting of the growth of the fungal mycelium, in particular by a heating, an irradiating and/or a chemically treating the green body. An arresting of growth may comprise killing the fungal mycelium. An arresting of the growth may also comprise killing parts of the fungal mycelium. An arresting of the growth may also comprise putting the fungal mycelium into a non-growing state, in particular into a state in which the fungal mycelium has very low activity, such as oxygen consumption and nutrient consumption. A heating is a heating up to a predetermined temperature. A heating may comprise a holding at a predetermined temperature. For example, a heating may comprise holding at a predetermined temperature for at least 10 minutes, more than 10 minutes, more than 30 minutes, more than 1 hour, more than 12 hours, and/or more than 24 hours. The predetermined temperature may be higher than room temperature. The predetermined temperature may be higher than 30° C., 50° C., 100° C. or 200° C. A heating process may take place in an oven. A heating process may also take place in an autoclave. A heating may also be carried out in the production system and/or in a growth device. An irradiating may comprise an irradiating with UV rays. An irradiating may also comprise an irradiating with infrared rays. An irradiating may also comprise an irradiating with radioactive radiation, in particular with alpha radiation, beta radiation, X-rays, gamma radiation and/or neutron radiation. A chemically treating may comprise a treating with chemical substances, in particular with an alcohol, isopropanol, acetone, an acid, a base and/or a salt. The arresting of the growth may cause hardening, stiffening and/or compaction of the green body. The arresting of the growth may also comprise a sterilizing.

Through the arresting of the growth, undesirable further growth of the fungal mycelium is prevented. Further growth may, for example, break down particles in such a way that the mechanical properties of the green body are impaired. Through the arresting of the growth the fungal mycelium may be prevented from growing into unwanted areas of a particle layer. Through the arresting of the growth the fungal mycelium may be prevented from forming fruiting bodies. Through the arresting of the growth the fungal mycelium may be prevented from rotting. Through the arresting of the growth the useful life of the produced body may be extended.

In a further embodiment of the method, the method comprises an applying of an adhesive, in particular an adhesive comprising alginate, in a defined area of the particle layer, the applying of the bonding agent preferably being carried out via a first nozzle and the applying of the adhesive being carried out via a second nozzle. The first nozzle may be arranged next to the second nozzle. The first nozzle and the second nozzle may be arranged on the same effector. The first nozzle and the second nozzle may be arranged on different effectors. The first nozzle and the second nozzle may be arranged on the same robot. The first nozzle and the second nozzle may be arranged on different robots. During the applying, the first nozzle and the second nozzle may be operated simultaneously. An operating is a conveying of bonding agent and/or adhesive. During the applying, the first nozzle may first perform a step of applying on a particle layer, and then the second nozzle performs a step of applying on a particle layer. The nozzles may be guided along the same movement paths during application. The nozzles may also be guided along different paths. The nozzles may have the same diameter. The nozzles may also have different diameters. The nozzles may be configured to convey solid material, liquid material and/or suspensions.

The adhesive supports the connection of the fungal mycelium with particles. The supporting may be an adhesive bonding. Through the adhesive bonding the position of the bonding agent within a defined area may be supported or enabled. The adhesive may thus support a more precise determination of the geometry of the three-dimensional body to be produced. Through applying of the adhesive through a second nozzle a more precise and flexible application may be enabled. For example, adhesive may only be applied in areas that are subject to particular mechanical stress, thereby supporting the mechanical strength in these areas. By using a second nozzle, the shelf life of a bonding agent may be increased because the fungal mycelium cannot degrade or decompose an adhesive prematurely. By using a second nozzle, the nozzle may be adapted more easily and flexibly to the properties of the adhesive. By using a second nozzle, the use of adhesives and bonding agents that are difficult to mix or otherwise incompatible with each other may be made possible. By using a second nozzle, the use of adhesives and bonding agents comprising different phases, such as a solid and a liquid phase, may be made possible.

### BRIEF DESCRIPTION OF THE FIGURES

FIG. 1 schematically illustrates a production system according to an embodiment of the present invention.

FIG. 2 schematically illustrates a cross-section of the production system of FIG. 1.

FIG. 3 schematically illustrates another cross-section of the production system of FIG. 1.

FIG. 4 schematically illustrates a cross-section of the production system from FIG. 1 with several particle layers, a green body and a ventilation device.

FIG. 5 schematically illustrates a process for producing a three-dimensional body using the production system of FIGS. 1 to 4.

FIG. 6 schematically illustrates a cross-section of several particle layers with an applied bonding agent.

FIG. 7 schematically illustrates a cross-section of several particle layers with an applied bonding agent and grown-together fungal mycelium.

### DETAILED DESCRIPTION OF THE EMBODIMENTS

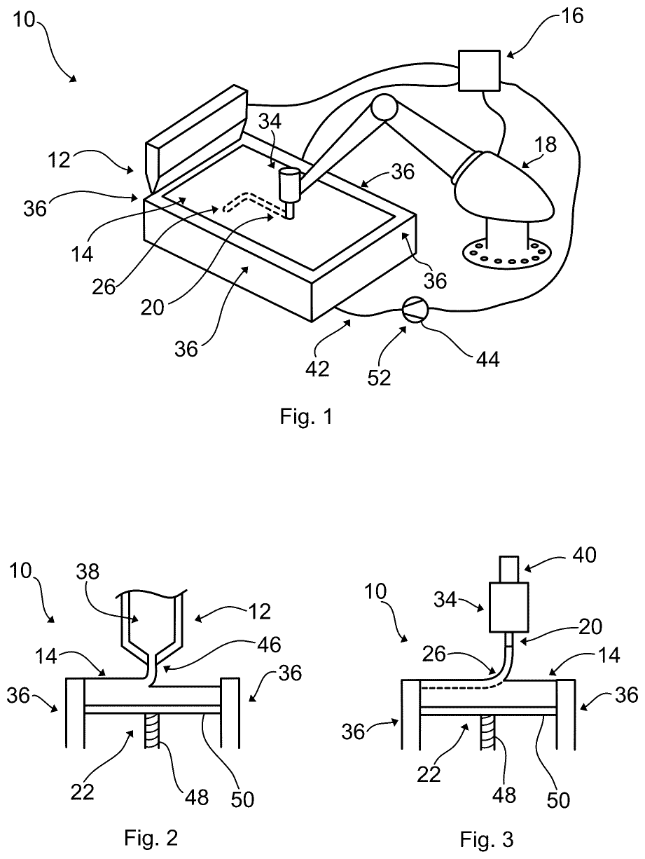

FIG. 1 schematically illustrates a production system 10 for the layer by layer production of a three-dimensional body according to an embodiment of the present invention. A particle layer 14 and a bonding agent 26 are arranged on the production system 10 in FIG. 1. The production system 10 comprises a coater 12, a control device 16, a robot 18, a print bed 22, and margin areas 36. In addition, the production system may comprise a ventilation device 52.

As shown in FIGS. 2 to 4, the print bed 22 comprises a threaded spindle 48, ventilation holes 30 and a print bed plate 50. The print bed 22 is arranged between the margin areas 36. The print bed 22 is configured to receive at least one particle layer 14, which may be laid out by means of the coater 12 described below. A receiving may be a stacking of the particle layer 14 over the print bed plate 50. The print bed plate 50 is rectangular but may also be square. The margin areas 36 of the manufacturing system 10 are arranged around a print bed 22. The margin areas 36 are configured to prevent the particle layers 14 from leaving the manufacturing system 10. The margin areas 36 enclose a rectangular area. However, the margin areas 36 may also enclose a square area.

The coater 12 is configured to lay out particles from a particle reservoir 38 on the print bed 22 and on a particle layer. The coater 12 is moved from an outer edge 36 of the production system 10 to an opposite outer edge 36 of the production system 10. The robot 18 comprises an effector 34, a nozzle 20 and a bonding agent reservoir 40. The robot 18 is configured to apply the bonding agent 26 via the effector 34 and the nozzle 20 from the bonding agent reservoir 40 in a defined area of the particle layer 14. The robot 18 is configured to move the effector 34 over the particle layer. The robot 18 is arranged next to the margin areas 36 and thus outside the print bed 22. The effector 34 is arranged at one end of the robot 18. The effector 34 is configured to apply the bonding agent 26 from the bonding agent reservoir 40 to a particle layer 14. The effector 34 is a peristaltic effector.

The control device 16 is configured to control the coater 12, the robot 18 and the print bed 22. In addition, the control device 16 may control a ventilation device 52. The control device 16 shown comprises a computer and is connected to the controlled devices via a bus system. The production system 10, in particular the print bed 22, the coater 12 and the control device 16, are configured to arrange a particle layer 14 over the print bed 22 as described below. The margin areas 36 enclose a rectangular area. The particle layer 14 and the print bed 22 are arranged between the margin areas 36 in this rectangular area. A particle layer 14 comprises particles 28 forming a layer covering an area spanned between the margin areas 36. The particles 28 may be made of wood, in particular beech.

The bonding agent 26 used by the production system 10 of the present invention is a fungus-containing bonding agent. The bonding agent 26 comprises a fungal mycelium. Alternatively or additionally, the bonding agent 26 may also comprise fungal spores and/or the fruiting body of a fungus. The fungal mycelium 24 is a part of a fungus, in particular Trametes and/or Ganoderma. The fungal mycelium is alive.

FIG. 2 schematically illustrates a cross-section of the production system 10, in particular of the coater 12 and the print bed 22. The cross-section also illustrates a cross-section of the particle layers 14 laid out by means of the production system 10 of the present invention. The respective particle layer 14 is bounded by margin areas 36 of the production system 10. The coater 12 comprises a particle reservoir 38, which holds particles 28, and a coater opening 46. The print bed 22 comprises a print bed plate 50, which may be a rectangular or square plate. The print bed plate 50 may be formed from metal, plastic or ceramic. The print bed plate 50 is connected to the threaded spindle 48. The threaded spindle 48 may be made of metal, plastic or ceramic. The print bed plate 50 may be guided on rails. Several particle layers 14 may be arranged one above the other in the vertical direction above the print bed 22 by means of the coater 12. The particle layers are limited by the print bed and the margin areas. The coater 12 may lay out a first particle layer and then a further particle layer on this first particle layer.

FIG. 3 schematically illustrates a cross-section of the production system, in particular of the effector 34, the nozzle 20, the bonding agent reservoir 40 and the print bed 22. The cross-section also illustrates a cross-section of the particle layers 14 laid out by the coater 12 and the bonding agent 26 applied by the nozzle 20. The particle layer 14 is bounded by margin areas 36 of the production system 10. The bonding agent reservoir 40 is arranged above the effector 36.

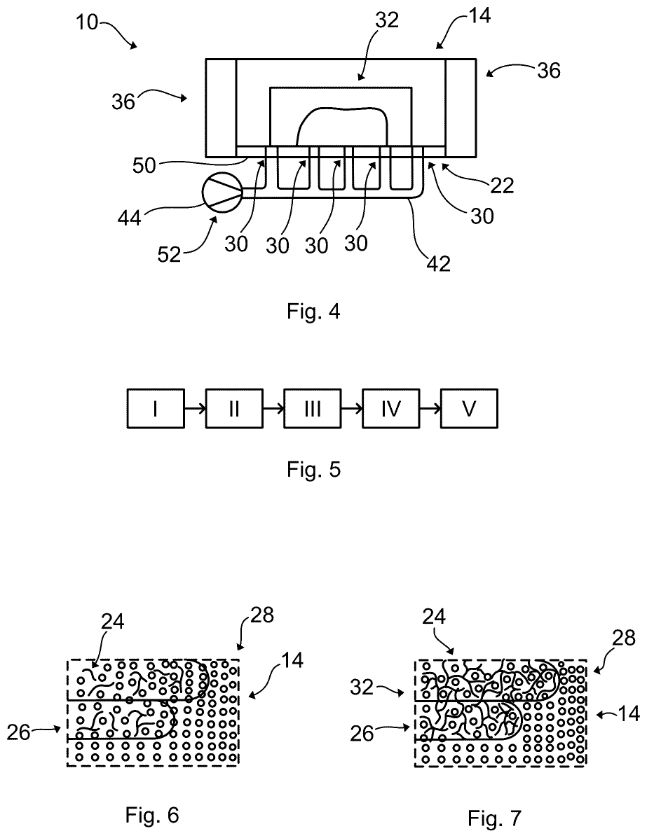

FIG. 4 schematically illustrates a cross-section of the production system 10 with several particle layers 14, a green body 32 and a ventilation device 52. The green body 32 forms a curved structure. The particle layers 14 and the green body 32 are arranged above a print bed 22. The print bed 22 comprises ventilation holes 30 which are connected to a ventilation device 52. The green body 32 comprises a fungal mycelium 24 and particles 28, more precisely particles of the particle layer 14, which was laid out by means of the coater 12. The particles 28 are connected via the fungal mycelium. The fungal mycelium is grown-together with the particles 28 and with itself. The green body 32 forms a rigid structure. The green body 32 may comprise empty spaces, in particular pores. The green body 32 may comprise a high humidity, in particular a higher humidity than the particle layers 14. The green body 32 may comprise nutritional material.

The ventilation device 52 comprises ventilation tubes 42 and a compressor 44. The compressor 44 is configured to compress air and to supply it through the ventilation tubes 42 via the ventilation holes 30 to the particle layers 14 and the green body 32. The air thus supplied is ambient air. The supplied air may also be sterile air. The supplying of air is a ventilating. The fungal mycelium 24 is configured to use the oxygen in the supplied air to grow and/or decompose wood. The fungal mycelium 24 is configured to mechanically connect the particles of the particle layer 14 with one another. In particular, the fungal mycelium is configured to grow in and/or around the particles 28. The fungal mycelium may be configured to decompose the particles 28.

FIG. 5 schematically illustrates a method for producing a three-dimensional body by means of the production system 10 described above. The control device 16 described above is configured and set up to carry out the method described below with reference to FIG. 5, in particular to control the various components of the production system 10 for carrying out the method accordingly. The method comprises a step of providing I the above-described fungus-containing bonding agent 26, a step of laying out II the above-described particles 28 in the above-described particle layer 14 over the print bed 22, a step of applying III the above-described fungus-containing bonding agent 26 in a defined area of the particle layer 14, a step of inducing IV a growth of a fungal mycelium 24 from the above-described fungus-containing bonding agent 26 for structurally connecting particles 28 of the particle layers 14 to form a green body 32, and a step of exposing V the above-described green body 32.

The providing I comprises filling the bonding agent reservoir 40 with bonding agent 26. The providing I may also comprise a manufacturing of the bonding agent 26. In the laying out II, particles 28 are applied by the coater 12 in a particle layer 14 on the print bed 22. For this purpose, the coater 12 is moved from a starting position along an extension direction of the production system 10 and lays out the particle layer 14 of uniform thickness along the movement path of the coater 12 via the coating opening 46. When returning to the starting position, the coater 12 may spread the particle layer 14 flat and/or scrape off excess particles 28. Excess particles 28 may be particles that are above an extension height of the margin areas 36 or above a predetermined height. The excess particles 28 may fall into a catching opening and be collected for reuse. Laying out II may be carried out in a layer by layer manner. Laying out II in layer by layer means that a step of laying out II is performed repeatedly and the print bed 22 is lowered between each repetition. Further processing steps may take place between each repetition, in particular an applying III may take place between each repetition.

In application III, a bonding agent 26 is applied to a defined area of the designed particle layer 14 via the effector 34 and the nozzle 20. The defined area may be calculated by a computer or specified by a user. The applying III comprises a placing of the connecting agent 26 on the particle layer 14. The applying III may also comprise a pressing into the particle layer 14, a displacing of the particles 28, a seeping between the particles 28, a wetting of the particles 28 and/or a gluing together of the particles 28 of the particle layer 14. The applying III of the bonding agent 26 may be carried out in a layer by layer manner. A applying III layer by layer means that a step of the applying III is carried out repeatedly and the print bed 22 is lowered between each repetition. Further processing steps may take place between each repetition, in particular a laying out II may take place between each repetition.

During the inducing IV of the growth, the fungal mycelium 24 grows. In doing so, it connects particles 28 from the particle layer 14 with one another. In doing so, it connects different areas of the fungal mycelium 24 with one another. The fungal mycelium 24 may also grow from fungal spores. In the exposing V, the green body 32 is removed from the particle layers 14, or the particle layers 14 are removed from the green body 32, or the green body 32 is removed from the manufacturing system 10. The exposing also comprises lifting the green body 32 out of the particle layers 14. The exposing may be performed during the step of inducing IV growth. During this, the fungal mycelium 24 grows before the exposing while the green body 32 is embedded in particle layers 14, as well as after the exposing. After the exposing, the green body may be sprayed. Spraying may provide moisture, food, antibiotics, and/or adhesive. Spraying may be a step of inducing IV a growth.

FIG. 6 schematically illustrates a cross-section of several particle layers 14 with an applied bonding agent 26. The cross-section is a vertical cross-section through several particle layers 14, which means that the cross-section is parallel to a direction of action of gravity. The cross-section schematically shows the state of the bonding agent 26 shortly after the step of applying III, for example one hour after the applying III. FIG. 6, like the other figures, is not to scale. The illustration is for illustrative purposes only. The bonding agent 26 is arranged between the particles 28 of the particle layers 14 and is located in defined areas. The bonding agent 26 comprises a fungal mycelium 24. The fungal mycelium 24 consists of individual hyphae. The hyphae or the fungal mycelium 24 are largely not cross-linked with one another and are located within the area in which they were applied. The particles 28 of the particle layer 14 have not been or only slightly decomposed.

FIG. 7 schematically illustrates the cross-section of FIG. 6 several days after the step of applying III, for example five days after application. FIG. 7 is also not to scale. The fungal mycelium 24 forms a network that has grown together and is interconnected.

The fungal mycelium 24 has penetrated the particles 28 and connects them to each other. The fungal mycelium 24 may transmit forces. The fungal mycelium 24, together with the enclosed particles 28, thus forms a green body 32. The particles 28, which are enclosed by the fungal mycelium 24, have been partially decomposed. The fungal mycelium 24 is grown together within the defined areas but has grown only slightly beyond this area. The fungal mycelium 24 has grown within the defined area due to the moistness of the bonding agent 26. The fungal mycelium 24 has grown only slightly outside the defined area due to the conditions in the particle layer 14. The conditions may for example be moisture. Through the applying III of the bonding agent 26, growth conditions for the fungal mycelium 24 in the defined area were achieved in a targeted manner. Thus, the growth of the fungal mycelium 24 was specifically controlled in order to obtain a desired form of a green body 32.

### REFERENCE SIGNS

10 Production system
12 Coater
14 Particle layer
16 Control device
18 Robot
20 Nozzle
22 Print bed
24 Fungal mycelium
26 Bonding agent
28 Particles
30 Ventilation holes
32 Green body
34 Effector
36 Margin area
38 Particle reservoir
40 Bonding agent reservoir
42 Ventilation tubes
44 Compressor
46 Coater opening
48 Threaded spindle
50 Print bed plate
52 Ventilation device
I Providing bonding agent
II Laying out particles
III Applying bonding agent
IV Inducing growth
V Expose green body

1. A method for producing a three-dimensional body layer by layer, the method comprising at least the following steps:
providing a fungus-containing bonding agent;
laying out particles in at least one particle layer over a print bed;
applying the fungus-containing bonding agent in a defined area of the particle layer;
inducing a growth of a fungal mycelium from the fungus-containing bonding agent to structurally connect particles of the particle layer to form a green body; and
exposing the green body.

2. The method according to claim 1, wherein:
providing the fungus-containing bonding agent comprises providing a fungus-containing bonding agent comprising a nutrient for the fungus and/or an adhesive.

3. The method according to claim 1, wherein:
providing the fungus-containing bonding agent comprises providing a fungus-containing bonding agent with a wood-decomposing fungus.

4. The method according to claim 1, wherein:
laying out the particles comprises laying out particles of organic material.

5. The method according to claim 1, wherein:
the method comprises sterilizing the particles before laying out the particles by a temperature greater than 30° C. and/or a pressure greater than 1.05 bar.

6. The method according to claim 1, wherein:
inducing a growth comprises at least one of the following steps:
adjusting the temperature,
adjusting the humidity, and
adjusting the oxygen content.

7. The method according to claim 1, wherein:
the method comprises ventilating the green body with sterile air, wherein the ventilating of the green body comprises ventilating through a device in the printing bed.

8. The method according to claim 1, wherein:
the method comprises transferring the at least one particle layer and the applied bonding agent from a production device to a growth device.

9. The method according to claim 1, wherein:
the method comprises arresting the growth of the fungal mycelium by heating, irradiating and/or chemically treating the green body.

10. The method according to claim 1, wherein:
the method comprises applying an adhesive comprising alginate in a defined area of the particle layer, wherein the application of the bonding agent is carried out via a first nozzle and the application of the adhesive is carried out via a second nozzle.
